(19) United States
(12) Patent Application Publication
(10) Pub. No.: US 2019/0085871 A1
(43) Pub. Date: Mar. 21, 2019

(54) Valve Module, Valve Assembly and Method for Operating a Valve Assembly

(71) Applicant: FESTO AG & Co. KG, Esslingen (DE)

(72) Inventor: Michael Berner, Kirchheim (DE)

(21) Appl. No.: 15/769,925

(22) PCT Filed: Oct. 27, 2016
(86) PCT No.: PCT/EP2016/075982

§ 371 Date: Apr. 20, 2018

(30) Foreign Application Priority Data
Oct. 30, 2015 (DE) 102015221259.9

(51) Int. Cl. F15B 13/08

(52) U.S. Cl. CPC F15B 13/0871; F15B 13/0857; F15B 13/0817; F15B 2211/327; F15B 2211/30575; F15B 2211/329; F15B 13/0839

(57) ABSTRACT

A valve module for mounting to a fluid distribution device, including a main body, which has two mutually opposed interface surfaces, which are designed for connection to a valve module or to a fluid distribution device wherein a distribution device connection for fluid coupling to a distribution device connection of the fluid distribution device or to a distribution device connection of another valve module and a working connection for fluidic coupling to a working connection of the fluid distribution device or a working connection of another valve module, is formed on each of the interface surfaces, wherein the main body is permeated by a fluid channel which extends between the two distribution device connections and the two working connections and to which a valve device is assigned to influence an open fluid channel cross-section.

The invention relates to a valve module for mounting to a fluid distribution device, comprising a main body, which has two mutually opposed interface surfaces designed to be connected to a valve module or a fluid distribution device. The invention further relates to a valve assembly and to a method for operating a valve assembly.

EP 1 284 371 B1 discloses a fluid control apparatus which comprises a main fluid distribution device which defines a mounting plane, on which are mounted a plurality of fluid control devices arranged consecutively in the direction of extension of a first axis of alignment and fluid control devices which are in fluid connection with the main fluid distribution device, a plurality of electro-fluidic control device modules which are arranged consecutively in the direction of extension of a second axis of alignment and at least some of which are in the form of electrically operable fluid control modules being provided, which are oriented in such a way that the second axes of alignment extend in parallel with one another and at the same time at a right angle to the mounting plane of the main fluid distribution device, each control device containing an electrical control device signal distribution device extending in the direction of extension of the second axis of alignment, which distribution device is in electrical contact with the control device modules, all the control device signal distribution devices being electrically connected to the same electrical main signal distribution device which extends in the direction of extension of the first axis of alignment.

The object of the invention is to provide a valve module, a valve assembly and a method for operating a valve assembly which have a greater range of functions.

This object is achieved for a valve module of the type mentioned at the outset with the features of claim 5. In this case, it is provided that a distribution device connection for fluid coupling to a distribution device connection of the fluid distribution device or to a distribution device connection of another valve module and a working connection for fluid coupling to a working connection of the fluid distribution device or a working connection of another valve module is formed on each of the interface surfaces, the main body being permeated by a fluid channel which extends between the two distribution device connections and the two working connections and to which channel a valve device is assigned to influence an open fluid channel cross-section.

The fluid channel thus ensures a fluidically communicating connection between the respective distribution device connections which are assigned to the mutually opposed interface surfaces. The fluid channel further ensures a fluidically communicating connection between the respective working connections which are assigned to the mutually opposed interface surfaces. In addition, the fluid channel is used to connect the distribution device connections and the working connections for fluid communication as soon as the valve device arranged in the fluid channel releases at least part of an open cross-section of the fluid channel, which is also referred to as the fluid channel cross-section.

As a result of the connection of the two working connections which are assigned to the opposed interface surfaces, in the case of a coupling of at least two valve modules, an increase in a maximum flow rate which can be provided at the working connection of one of the valve modules is made possible for a fluid flow which flows from the distribution device connection through the fluid channels to the working connection or flows from the working connection through the fluid channels to the distribution device connection. The increase in the maximum flow rate at a working connection of a valve module results from the parallel fluidic connection of at least two valve modules. In this case, the flow rate at the working connection of the one valve module is determined by the functional positions of the valve devices of the valve modules which are connected in parallel in each case, the maximum flow rate at said working connection being determined preferably by the sum of the maximum flow rates through the individual valve modules. In this case, it is assumed for example that at least two to five valve modules can be fluidically connected in parallel without throttle losses at the distribution device connections and/or the working connections between the valve modules leading to an impairment of the fluid distribution of the one working connection which is provided for coupling to the fluid distribution device.

In the case of a practical application of the valve modules, it is provided for example that a first valve module is mounted by a first interface surface to a fluid distribution device, and that the distribution connection and the working connection are connected at said interface surface to a corresponding distribution connection and working connection of the fluid distribution device. Furthermore, it is assumed for example that a first interface surface of a second valve module is arranged in a sealing manner on a second interface surface of the first valve module. In this case, fluidic communication is provided between firstly the respective distribution connections and secondly the respective working connections of the two valve modules. The distribution connection and the working connection on the second interface surface of the second valve module are blocked by suitable blocking means to prevent undesirable fluid discharge there.

If a fluid flow is thus provided at the distribution device connection of the first valve module, said flow reaches both the first valve module and the second valve module and subsequently, after passing the respective valve arrangement which must be in an at least partially open position, can flow to the respective working connection. Since for example two valve modules are interconnected, at the working connection which is assigned to the first interface surface of the first valve module, a maximum fluid flow rate can be provided. Said fluid flow rate corresponds to a sum of the maximum fluid flow rate through the first valve module and the maximum fluid flow rate through the second valve module. In the case of the example described above, for the working connection, which is assigned to the fluid distribution device, of the first valve module, it is thus made possible, by means of the second valve module, to double the fluid flow rate, which could be provided only by the first valve module. In the case of an assembly of more than two valve modules, at the working connection which is assigned to the fluid distribution device, a multiple of the fluid flow rate can be provided, which can flow through a single valve module so that, in a simple manner, the maximum available fluid flow rate can be adapted to the working connection of the fluid distribution device by means of a suitable arrangement or cascading of valve modules.

The dependent claims relate to advantageous developments of the invention.

It is expedient for the valve device to comprise a valve seat formed in the fluid channel and a valve member which is movably arranged in the fluid channel for temporarily sealing abutment against the valve seat, and an adjusting means which is designed for introducing an adjusting movement onto the valve member. Preferably, the valve device comprises an electrically controllable adjusting means such as a magnetic coil assembly or a piezoelectric actuator so that the valve device can influence the open cross-section of the fluid channel according to an electric control signal. In this case, the valve member can be connected directly to a movable part of the adjusting means or can be coupled for movement to the movable part of the adjusting means by a coupling device such as a coupling rod. More preferably, the valve device is in the form of a (piezoelectric) proportional valve, in the case of which a predeterminable, proportional relationship between the electric control signal and the open cross-section of the fluid channel which is released by the valve device is ensured.

In one advantageous embodiment of the invention, it is provided that, in the main body, a plurality of fluid channels having valve devices assigned thereto in each case are formed, each of the fluid channels being extended between an individually assigned distribution device connection pair and the shared working connections. Preferably, it is provided that, in the main body, two fluid channels are formed, the first fluid channel being provided for fluidically communicating connection to a first distribution channel formed in the fluid distribution device, a pressurised fluid, in particular compressed air, being provided in said distribution channel. Furthermore, it is preferably provided that the second fluid channel is provided for fluidically communicating connection to a second distribution channel formed in the fluid distribution device, said distribution channel being designed in particular for a discharge of fluid. As a result of this, a single valve module can selectively provide and discharge pressurised fluid at the working connection which is fluidically coupled to the fluid distribution device. When a second valve module is arranged on an interface surface, which faces away from the fluid distribution device, of the first valve module, as a result of the above-described configuration of the distribution connections and the working connections as well as the fluid channels with the valve devices received therein, the valve modules are fluidically connected in parallel. Thus, at the working connection which is fluidically coupled to the fluid distribution device, a greater volume flow of fluid can be provided or discharged than when using a single valve module.

Optionally, it can also be provided that the valve modules to be coupled to one another do not have an identical design. If for example only an increase in a maximum fluid inflow in comparison with a single valve module is required, whereas a maximum fluid outflow can remain at the level of the single valve module, then it can also be provided to couple an additional valve module to the valve module which is equipped for example with two fluid channels, which additional valve module has only a single fluid channel having the corresponding connections and the corresponding valve device, to be able to thereby provide an additional flow rate only on the inflow side.

In another embodiment of the invention, it is provided that, in the main body, a control circuit is arranged to electrically control the at least one valve device, in each case one connection means, in particular in the form of a plug-in connector, being assigned to the control circuit on both interface surfaces, which connection means is designed for electrical coupling to an electrical lead assembly arranged in the fluid distribution device or to a control circuit of another valve module. Electrical interlinking of a plurality of valve modules which are to be fluidically connected in parallel is thus also possible. Preferably, the control circuit is provided for communication with control circuits of adjacent valve modules and for communication with a control unit arranged in the fluid distribution device or assigned to the fluid distribution device, said control unit being configured to provide control signals to the control circuits of the valve modules. Preferably, it is provided that control circuits of adjacent valve modules are configured to exchange information with one another in order to for example to be able to share with the control unit how many valve modules are arranged so as to be fluidically connected in parallel so that the control unit can provide suitable control signals for the respective control circuits in order to be able to provide a sufficiently great fluid flow rate at the respective working connection.

The object of the invention is achieved according to a second aspect with a valve assembly, comprising a fluid distribution device which has a coupling face for connecting a valve module according to any of claims 5 to 8, wherein at least one distribution device connection for fluidically communicating connection to the distribution device connection of the valve module and at least one working connection for fluidically communicating connection to the working connection of the valve module are formed on the coupling face, wherein the fluid distribution device is permeated by at least one distribution channel which is connected to the distribution device connection for fluidic communication, and wherein the fluid distribution device has at least one working channel which opens out into a consumer connection on a connection face and which is connected to the working connection for fluidic communication, and to which at least one valve module according to any of claims 5 to 8 is assigned.

Such a valve assembly is designed to ensure a distribution of fluid to a fluid consumer, for example a pneumatic cylinder. For this purpose, the valve assembly comprises, in addition to one or more valve modules, a fluid distribution device in which both a distribution channel and a working channel are formed. In this case, a connection of the fluid consumer to a consumer connection assigned to the working channel is provided, whereas the distribution channel can be connected for example to a source of fluid, in particular a source of compressed air, or to a fluid outlet to which in particular a sound absorber is assigned.

In one development of the valve assembly, it is provided that the fluid distribution device is permeated by a plurality of fluidically separately formed distribution channels which open out onto different distribution device connections which are formed on the coupling face. For example, one of the distribution channels can be designed to provide a pressurised fluid, whereas another distribution channel can be designed to discharge pressurised fluid.

In another embodiment of the valve assembly, it is provided that, in the fluid distribution device, an electrical lead assembly is formed, which is connected in an electrically conductive manner to a connection means, in particular a plug-in connector, which is assigned to the coupling face. By means of the lead assembly, analogue or digital signals, in particular signals according to a fieldbus protocol, can be provided for the control circuits in the valve modules. Furthermore, the lead assembly can also be used to provide electric power to the control circuits so that said circuits can distribution the adjusting means, which are preferably in the form of electric drives, with a sufficient amount of electrical energy.

Preferably, it is provided that at least one sensor means from the group comprising: pressure sensor, flow rate sensor and temperature sensor is assigned to the working channel. Using the sensor means, control, in particular flow control, for the fluid flow to be provided at the working connection can be achieved using the control circuits, the control circuits being able to be designed to either forward the sensor signal to a superordinate control unit which is connected to the lead assembly, or to directly control the respective valve device. Additionally or alternatively, other controlled variables can also be influenced by the control circuits. More preferably, it is provided that, within a group of valve modules connected in parallel, one of the control circuits within said group is used as a leader (master) circuit, whereas the rest of the control circuits in this group are used as follower (slave) circuits, to thereby allow advantageous local control of the fluid flow at the working connection.

It is advantageous if, in the case of the valve assembly, the at least one distribution channel and the lead assembly of the fluid distribution device each open out onto mutually opposed connection faces, and if mutually facing connection faces of a plurality of fluid distribution devices are aligned to form a distribution device body. In this embodiment of the fluid distribution device, a particularly compact arrangement of both the fluid distribution devices and the valve modules aligned therewith is possible, the at least one distribution channel and the lead assembly being extended along a direction of alignment for the fluid distribution devices, and the valve modules are coupled to one another transversely to said direction of alignment. As a result, for each of the fluid distribution devices, an individual number of valve modules can be fluidically connected in parallel.

In another embodiment of the valve assembly, it is provided that, in the fluid distribution device, a control unit is arranged, which is designed to provide actuating energy, in particular electrical energy, to at least one adjusting means of at least one valve module, the control unit comprising at least one control interface which is preferably arranged on a connection face and is designed for connection of the control unit to at least one adjacently arranged control unit or to a superordinate controller. The control unit is thus used to control one or more valve modules, which each comprise one or more valve devices, control of a plurality of valve devices being carried out by the control unit in a preferably cascaded or quantised manner. In the case of a parallel fluid connection of a plurality of valve devices and a fluid requirement which is considerably lower than a maximum flow rate through the valve devices connected in parallel, only some of the of the valve devices are supplied with control signals from the control unit, whereas the rest of the valve devices do not receive any control signals. The control unit is designed for electrical connection to at least one adjacent control unit which can be arranged in an adjoining fluid distribution device and, for this purpose, comprises at least one control interface which is arranged on a connection face. Preferably, it is provided that the control unit comprises two control interfaces arranged on mutually opposed connection faces so that the fluid distribution device can be lined up between adjacently arranged fluid distribution devices, and an electrically communicating connection between all the fluid distribution devices is ensured. Optionally, it can be provided that a superordinate controller is assigned to a group of a plurality of fluid distribution devices arranged in an aligned manner, which controller is configured to coordinate the activities of the individual fluid distribution devices and the valve assemblies arranged thereon. The superordinate controller can be configured either for independent operation, optionally taking into account sensor signals from sensors which are assigned to the fluid distribution devices or are formed externally, or alternatively for communication with a main controller, in particular a programmable logic controller (PLC).

The object of the invention is achieved according to a third aspect with a method for operating a valve assembly having a parallel fluidic connection of a plurality of valve modules, comprising the following steps: determining a fluid flow requirement by means of a control unit with reference to a predeterminable discharge or an external requirement signal, generating a control signal group in the control unit according to the fluid flow requirement, providing the control signal group from the control unit to control circuits of the valve devices assigned in each case, wherein the control signal group for each valve device has an individual control signal. The fluid flow requirement corresponds to the fluid flow rate through the parallel connection of the valve assembles which is to be provided by the valve assembly according to an external requirement, for example a requirement of a fluid consumer such as an actuator. The fluid flow requirement is determined for example according to at least one sensor signal of a sensor which can be assigned to a fluid distribution device or the fluid consumer. The sensor signal can be processed in the controller, in particular on the basis of a predeterminable program sequence, in order to determine the fluid flow requirement. The controller is configured to provide an individual control signal according to the fluid flow requirement for each of the valve modules, in particular for each valve device in the assigned valve modules, the control signals being able to be the same or different for the respective valve devices.

In one advantageous development of the method, it is provided that the individual control signals are determined according to predeterminable threshold values for the respective valve device, the threshold values being linked to the fluid flow requirement. By means of this measure, it is ensured that fluid flow requirements for low flow rates, which are to be provided by the valve modules which are fluidically connected in parallel, can also be provided with great precision. Preferably, it is provided that, for each fluid flow requirement, a minimum number of valve devices are always controlled so that a summation of tolerances of all the valve devices which can be controlled by the controller occurs only when all the valve devices also have to be controlled to be able to meet the fluid flow requirement. For other cases in which control of one valve device or a low number of valve devices is sufficient to meet the fluid flow requirements, the deviations between the provided control signal or the control signal group and the actual volume flow are restricted to the tolerances of the individual valve device or the controlled group of valve devices.

It is thus provided that, according to the threshold values, in each case, activation ranges for the respective valve devices are determined within the fluid flow requirement, which ranges are selected in such a way that, in the case of a low fluid flow requirement, some of the valve devices are activated, and in the case of a high fluid flow requirement, all the valve devices are activated.

In another embodiment of the invention, it is provided that, in the case of a change in the fluid flow requirement, an overall change of the individual control signals is determined, and the individual control signals are optimised to achieve a minimal overall change. This measure is intended to ensure that a number of load cycles for the individual valve devices is kept to a minimum in order to be able to limit wear of the respective valve module and thus achieve the most favourable service life possible for the valve assembly.

An advantageous embodiment of the invention is shown in the drawings, in which:

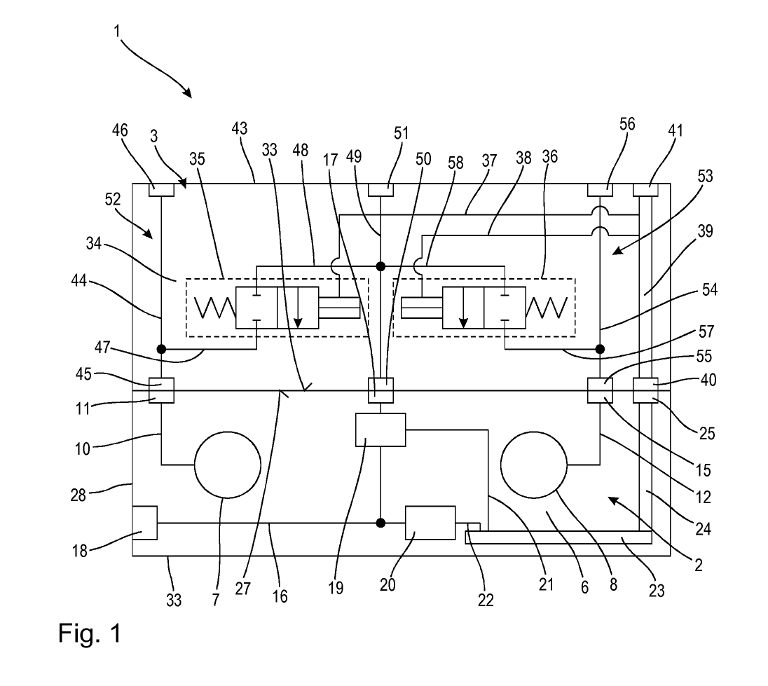

FIG. 1 shows a schematic sectional view of a valve assembly which comprises a fluid distribution device and a valve module,

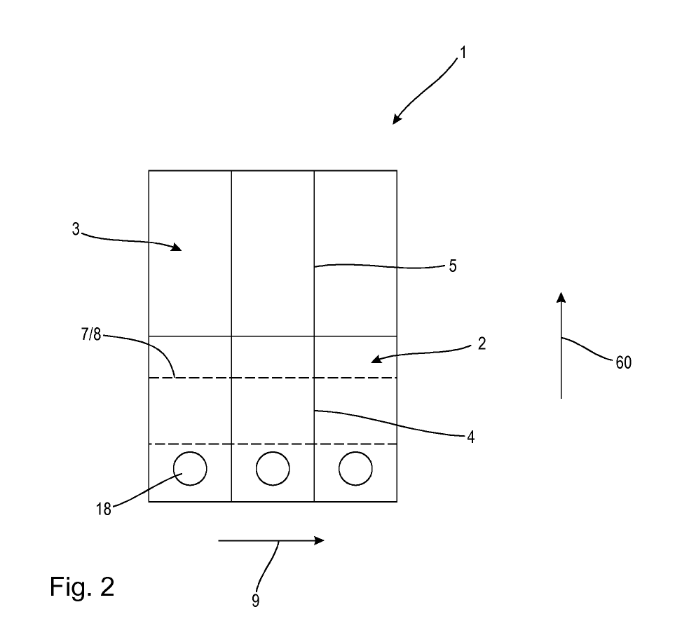

FIG. 2 shows a front view of a valve assembly comprising aligned fluid distribution devices and aligned valve modules,

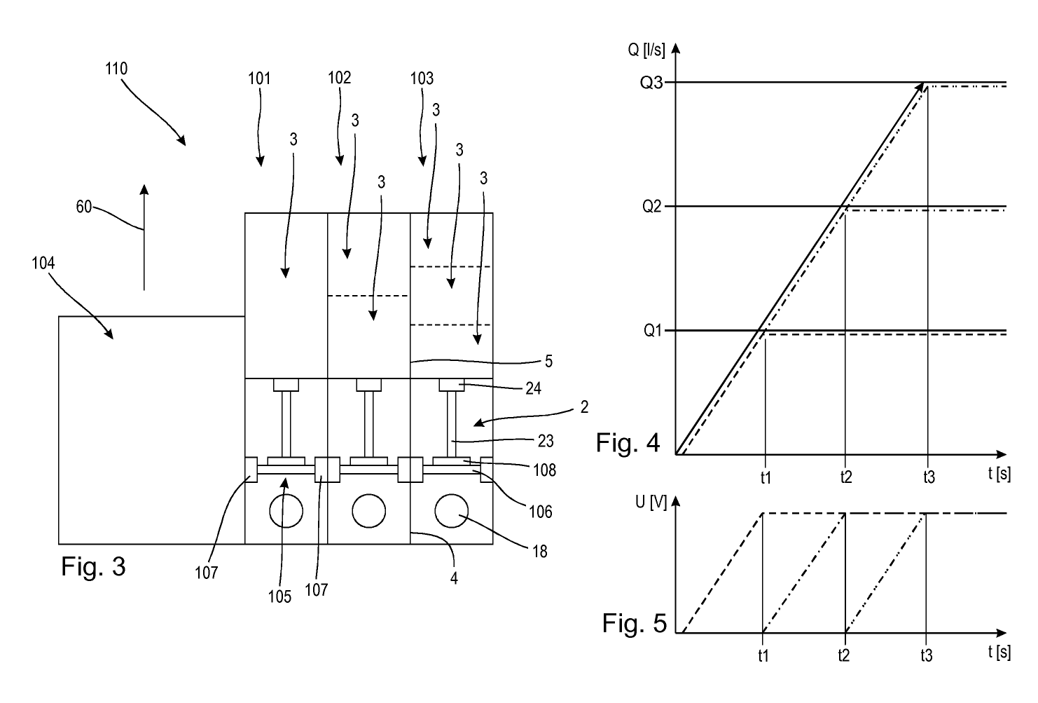

FIG. 3 shows a variant of the valve assembly according to FIG. 2, in which a plurality of valve modules are assigned to a plurality of fluid distribution devices respectively, and

FIG. 4 shows a schematic illustration for a control signal group for controlling a plurality of valve modules.

A valve assembly 1 shown schematically in FIGS. 1 and 2 comprises, purely by way of example, a plurality of fluid distribution devices 2 and valve modules 3 assigned to the respective fluid distribution devices 2 and is designed to provide and discharge a working fluid, in particular compressed air, to fluid consumers (not shown) which can be in particular pneumatic actuators.

Whereas FIG. 1 shows precisely one fluid distribution device 2 and precisely one valve module 3, FIG. 2 shows a plurality of fluid distribution devices 2 having, purely by way of example, two valve modules 3 aligned therewith in each case.

As can be seen in FIGS. 1 and 2, both the fluid distribution device 2 and the valve module 3 can have, purely by way of example, a cuboid-shaped design in each case, as a result of which, when the fluid distribution device 2 and the valve modules 3 are aligned, a planar abutment of opposing contact faces 4, 5 of the fluid distribution devices 2 and the valve modules 3, and thus a particularly compact arrangement of said components, can be achieved.

As can be seen in FIG. 1, the fluid distribution device 2 comprises a main body 6, which can be produced for example from plastics material. In the main body 6, for example two distribution channels 7, 8 are formed, the for example circular cross-section of which extends through the main body 6 perpendicularly to the illustration plane of FIG. 1. When a plurality of fluid distribution devices 2 are each aligned along a direction of alignment 9, as shown by way of example in FIG. 2, the distribution channels 7, 8 form continuous fluid channels.

Starting from the distribution channel 7, a connection channel 10 extends in the main body 6 to a distribution connection 11. Furthermore, in the main body 6, starting from the distribution channel 8, a connection channel 12 extends to a distribution connection 15. Furthermore, the main body 6 is permeated by a working channel 16 which extends from a working connection 17 to a consumer connection 18, a flow rate sensor 19 and a pressure sensor 20 being assigned to the working channel 16. Both the flow rate sensor 19 and the pressure sensor 20 are electrically connected via signal leads 21, 22 to a printed circuit board 23 in the form of a lead assembly, on which electrical and electronic components, in particular a microcontroller, can also be mounted, in a manner not shown in greater detail.

To the printed circuit board 23, an electrical connection line 24 is mounted, which line is provided with a plug-in connector 25, which is used as a connection means, on the end face thereof. Furthermore, contacting means which are not shown on both sides, formed on the respective contact faces 4, are assigned to the printed circuit board 23, said contacting means being used for electrical connection of the printed circuit board 23 to fluid distribution devices 2 which are arranged adjacently to printed circuit boards, in order to ensure electrical connection of the fluid distribution devices 2 shown schematically in FIG. 2.

The consumer connection 18 opens out onto a connection face 28 and can be configured for example in such a way that it can be used for connection of a fluid hose (not shown), in particular a compressed air hose.

The distribution connections 11 and 15, the working connection 17 and the connection means 25 are assigned to a coupling face 27 of the fluid distribution device 2, which, purely by way of example, has a planar design and is used to mount a correspondingly formed, for example planar, interface surface 33 of the valve module 3. The valve module 3 comprises a main body 34, which can be produced preferably from plastics material and in which, purely by way of example, two valve devices 35 and 36 are received. For example, the valve devices 35, 36 are 2/2-way valves comprising a piezoelectric drive, which valves are each electrically connected to a control circuit 39 via a control line 37, 38. The control circuit 39 is for example equipped with a microcontroller (not shown in greater detail) which, together with driver stages (also not shown in greater detail) allows electrical control of the two valve devices 35, 36 and can additionally communicate with the fluid distribution device 2. For this purpose, the control circuit 39 comprises in each case two connection means which are formed on end faces as plug-in connectors 40, 41, the plug-in connector 40 being assigned to the interface surface 33, whereas the plug-in connector 41 is assigned to an interface surface 43.

The valve device 35 is fluidically coupled via a fluid channel portion 44 which extends between a distribution connection 45 on the interface surface 33 and a distribution connection 46 on the interface surface 43 and which is connected to a fluid channel branch 47, which in turn is connected to the valve device 35. Furthermore, the valve device 35 is connected via a fluid channel branch 48 to a working channel 49 which extends between a working connection 50 on the interface surface 33 and a working connection 51 on the interface surface 43. The fluid channel portion 44, the fluid channels 47 and 48, and the working channel 49 thus form the fluid channel 52 for the valve device 35.

The valve device 36 is fluidically coupled via a fluid channel portion 54 which extends between a distribution connection 55 on the interface surface 33 and a distribution connection 56 on the interface surface 43 and which is connected to a fluid channel branch 57, which in turn is connected to the valve device 35. Furthermore, the valve device 35 is connected via a fluid channel branch 58 to the working channel 49, which is thus shared by the two valve devices 35, 36. The fluid channel portion 54, the fluid channels 57 and 58, and the working channel 49 thus form the fluid channel 53 for the valve device 36.

Since both the fluid channel portion 44 and the working channel 49 as well as the fluid channel portion 54 permeate the main body 34 between the two interface surfaces 33 and 43, purely by way of example, another valve module 3 can be mounted to the interface surface 43, as shown by way of example in FIG. 2. For proper operation of an individual valve module 3 or a group of a plurality of valve modules 3, it is necessary for the distribution connections 46 and 56 and the working connection 51 on the interface surface 43, to which no additional valve module 3 is mounted, to be closed by blocking means (not shown), for example blind plugs.

By aligning a plurality of valve modules 3 in a direction of alignment 60, which is oriented transversely to the direction of alignment 9, a fluid flow rate at the consumer connection 18 can be adapted according to requirements, each additional valve module 3 leading to an increase in the fluid flow rate at the consumer connection 18 provided that the capacity of the respective distribution channel 7 or 8 in the main body 6 of the fluid distribution device 3 is not exceeded.

For example, using two valve modules 3, as assigned to each of the fluid distribution devices 2 according to FIG. 2, leads to the fluid flow rate at the respective consumer connection 18 being doubled provided that in each case one of the two valve devices 35 and 36 in the two valve modules 3 is in a maximum open position.

In the case of a suitable configuration of the printed circuit board 23 and the control circuit 39, the valve assembly 1 shown in FIG. 2 can be provided for independent operation.

Preferably, the valve assembly 1 is provided for coupling to a bus node (not shown), via which bus communication with a superordinate control unit (also not shown), in particular a programmable logic controller (PLC), can be provided.

A valve system 110 shown schematically in FIG. 3 comprises, purely by way of example, a plurality of valve assemblies 101, 102 and 103 and a bus node 104 which is designed to couple the valve system 110 to a bus system (not shown) for connection to a superordinate controller (also not shown). For example, it can be provided that the bus node 104 receives control information from the superordinate controller via the bus system (not shown) and forwards said information to the assigned valve assemblies 101, 102 and 103 so that, in the valve assemblies 101, 102 and 103, in each case a fluid flow requirement for the respective consumer connection 18 can be determined from the control information, and corresponding control of the assigned valve modules 3 takes place. Additionally or alternatively, it can be provided that the control information is transmitted wirelessly, in this case the bus node comprises a transceiver unit for wirelessly transmittable control information or is in the form of a transceiver unit for wirelessly transmittable control information.

Each of the valve assemblies 101, 102 and 103 comprises in each case one fluid distribution device 2, to which at least one valve module 3 is mounted. Purely by way of example, in the case of the valve assembly 101, precisely one valve module 3 is mounted to the corresponding fluid distribution device 2, whereas in the case of the valve assembly 102, two valve modules 3 are mounted to the corresponding fluid distribution device 2, and the valve assembly 103 comprising three valve modules 3 mounted to the corresponding fluid distribution device 2. A maximum flow rate or volume flow can thus be provided at the consumer connection 18 of the valve assembly 101, such as can be provided by the valve device 35, 36 formed for example in the valve module 3. In contrast, at the consumer connection 18 of the valve assembly 102, compared with the valve assembly 101, double the maximum flow rate or volume flow, and, at the consumer connection 18 of the valve assembly 103, compared with the valve assembly 101, three times the maximum flow rate or volume flow can be provided.

The fluid distribution devices 2 of the valve assemblies 101, 102 and 103 each have the same structure as the fluid distribution device 2 shown in FIG. 1. As shown in FIG. 3, each of the fluid distribution devices 2 comprises a control unit 105, which is formed as a combination of a control interface which is arranged in a control board 106, in each case on an end face, and a microcontroller 108, which is arranged on the control board 106. Based on the illustration in FIG. 1, the control unit 105 is connected, via a connection line 24 and a connection means 25, so as to electrically transmit signals, to the at least one assigned valve module 3 and allows control of the at least one valve device 35, 36 provided in the valve module 3.

For example, the following mode of operation can be provided for the valve system 110: firstly, purely by way of example, control information is transmitted from the superordinate controller (not shown) via the bus system (also not shown) to the bus node 104. In the bus node 104, the incoming bus signals are for example converted into communication signals of a communication system (not shown in greater detail), which can be for example in the form of a multiconductor assembly (multipole) or an internal bus system. After the conversion in the bus node 104, the control information is thus forwarded to the control devices 105 in the respective fluid distribution devices 2 and there is processed in the respective microcontroller 108.

It is provided for example that the valve assembly 103 contains control information according to which a linearly increasing fluid flow is to be provided at the consumer connection 18, as represented by the straight line in FIG. 4. In order to be able to meet this fluid flow requirement according to the control information, it could be provided to control for example the total of three valve devices 35 in each case synchronously with a control signal group, which has in each case an identical control signal for each valve device 35. In this case, however, in the case of small flow rates/volume flows, a summation of the tolerances of all three valve devices 35 would have to be accepted, as a result of which an undesirably high influence of error would have to be accepted for the flow rate or volume flow at the consumer connection 18.

In practice, it is therefore provided to put into operation or stop as few of the valve devices 35 as possible in order to meet the respective fluid flow requirement, as shown in FIG. 4 by the summation of the individual fluid volume flows 116, 117 and 118, which can be provided by the individual valve modules 3 of the valve assembly 103.

The control signals 119, 120 and 121 for the individual valve modules 3 of the valve assembly 103 can be found in FIG. 5. From this, it can be seen that in the case of a linearly increasing fluid flow requirement, starting from a time to, initially only one of the valve modules 3 provides a fluid volume flow 116 by means of a corresponding control signal 119. At a time t1, a maximum flow rate or volume flow for the one valve module 3 is achieved, and therefore it is necessary to connect the second valve module 3 of the valve assembly 103 by means of the control signal 120. The connection of said second valve module 3 is carried out whilst simultaneously maintaining the control signal 119 and the fluid volume flow 116, which is linked thereto, for the first valve module 3. In the same way, at the time t2, the connection of the third valve module 3 by the control signal 121 is carried out whilst maintaining the control signals 119 and 120 and the fluid volume flows 116 and 117, which are linked thereto, for the two other valve modules 3.

On the basis of the maximum flow rate or volume flow for the respective valve module 3, in accordance with the illustration in FIG. 4, the threshold values 122, 123 for the connection or disconnection of the respective valve modules 3 can be determined, said threshold values 122 and 123 can be stored in particular in the microcontroller 108 of the control unit 105.

For example, it is thus provided that, for a flow rate or volume flow between the value 0 and the value Q1, only control of a single valve module 3 is carried out by a suitable control signal 119, whereas for a flow rate or volume flow between the value Q1 and the value Q2, the control signal 119 is kept at a maximum value, and an additional control signal 120 is set according to the fluid flow requirement in order to achieve the desired volume flow or flow rate. For a volume flow above the value Q2, both the control signal 119 and the control signals 120 are kept at a maximum value, whereas the additional control signal 121 is set according to the fluid flow requirement in order to achieve the desired volume flow or flow rate.

1. A method for operating a valve assembly, having a parallel fluid connection of a plurality of valve modules, comprising the steps of:
determining a fluid flow requirement by means of a control unit with reference to a predeterminable discharge or an external requirement signal;
generating a control signal group in the control unit according to the fluid flow requirement; and
providing the control signal group from the control unit to control circuits of the valve devices assigned in each case, wherein the control signal group for each valve device has an individual control signal.

2. The method according to claim 1, wherein the individual control signals are determined according to predeterminable threshold values for the respective valve device, the threshold values being linked to the fluid flow requirement.

3. The method according to claim 1, wherein, according to the threshold values, in each case, activation ranges for the respective valve devices are determined within the fluid flow requirement, which ranges are selected in such a way that, in the case of a low fluid flow requirement, some of the valve devices are activated, and, in the case of a high fluid flow requirement, all the valve devices are activated.

4. The method according to claim 3, wherein, in the case of a change in the fluid flow requirement, an overall change of the individual control signals is determined, and the individual control signals are optimised to achieve a minimal overall change.

5. A valve module for mounting to a fluid distribution device, comprising a main body, which has two mutually opposed interface surfaces which are designed for connection to a valve module or to a fluid distribution device, wherein a distribution device connection for fluid coupling to a distribution device connection of the fluid distribution device or to a distribution device connection of another valve module and a working connection for fluidic coupling to a working connection of the fluid distribution device or a working connection of another valve module, is formed on each of the interface surfaces, the main body being permeated by a fluid channel which extends between the two distribution device connections and the two working connections and to which a valve device is assigned to influence an open fluid channel cross-section.

6. The valve module according to claim 5, wherein the valve device comprises a valve seat formed in the fluid channel and a valve member which is movably arranged in the fluid channel for temporarily sealing abutment against the valve seat, and an adjusting means which is designed for introducing an adjusting movement onto the valve member.

7. The valve module according to claim 5, wherein, in the main body, a plurality of fluid channels having valve devices assigned thereto in each case are formed, each of the fluid channels being extended between an individually assigned distribution device connection pair and the shared working connections.

8. The valve module according to claim 5, wherein, in the main body, a control circuit is arranged for electrical control of the at least one valve device, in each case one connection means being assigned to the control circuit on both interface surfaces, which connection means is designed for electrical coupling to an electrical lead assembly arranged in the fluid distribution device or to a control circuit of another valve module.

9. A valve assembly, comprising a fluid distribution device which has a coupling face for connecting a valve module according to claim 5, wherein at least one distribution device connection for fluidically communicating connection to the distribution device connection of the valve module and at least one working connection for fluidically communicating connection to the working connection of the valve module are formed on the coupling face, wherein the fluid distribution device is permeated by at least one distribution channel which is connected to the distribution device connection for fluidic communication, and wherein the fluid distribution device has at least one working channel which opens out into a consumer connection on the connection face and which is connected to the working connection for fluidic communication, and comprising a valve module according to claim 5.

10. The valve assembly according to claim 9, wherein the fluid distribution device is permeated by a plurality of fluidically separately formed distribution channels which open out onto different distribution device connections which are formed on the coupling face.

11. The valve assembly according to claim 9, wherein, in the fluid distribution device, an electrical lead assembly is formed, which is connected in an electrically conductive manner to a connection means, which is assigned to the coupling face.

12. The valve assembly according to claim 9, wherein at least one sensor means from the group comprising: pressure sensor, flow rate sensor and temperature sensor is assigned to the working channel.

13. The valve assembly according to claim 9, wherein the at least one distribution channel and the lead assembly of the fluid distribution device each open out onto mutually opposed connection faces, and wherein mutually facing connection faces of a plurality of fluid distribution devices are aligned to form a distribution device body.

14. The valve assembly according to claim 9, wherein, in the fluid distribution device a control unit is arranged, which is designed to provide actuating energy, to at least one adjusting means of at least one valve module, the control unit comprising at least one control interface which is arranged on a connection face and is designed for connection of the control unit to at least one adjacently arranged control unit or to a superordinate controller.
